(19) United States
(12) Patent Application Publication
(10) Pub. No.: US 2005/0285004 A1
(43) Pub. Date: Dec. 29, 2005

(54) Over-under desk apparatus and method

(75) Inventors: Richard James Elgie, Los Gatos, CA (US); Timothy James Brophy, Sonoma, CA (US); Adam Ackley Carr, Brookline, MA (US); David Pitcher, Worcester, MA (US); Vito Lore, Providence, RI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Acco Brands, Inc.

(21) Appl. No.: 11/122,783

(22) Filed: May 4, 2005

Related U.S. Application Data
(60) Provisional application No. 60/612,280, filed on Sep. 21, 2004.
(60) Provisional application No. 60/569,031, filed on May 6, 2004.

(51) Int. Cl. B68G 5/00; A47B 91/00

(52) U.S. Cl. 248/346.01

(57) ABSTRACT

A method is disclosed. The method includes obtaining an apparatus including a platform and at least one support for use over or under a desk surface, attaching the apparatus under the desk surface, and placing the apparatus over the desk surface

### CROSS-REFERENCES TO RELATED APPLICATIONS

This patent application is a non-provisional of and claims the benefit of the filing date of U.S. provisional patent application Nos. 60/612,280 filed on Sep. 21, 2004 and 60/569,031 filed on May 6, 2004, all of which are herein incorporated by reference in their entirety for all purposes.

### BACKGROUND OF THE INVENTION

There are many commercially available monitor stands that are used on a desk surface. There are also many commercially available keyboard holders for use under a desk surface. Such products, however, are of limited use as they can be used only exclusively over a desk surface or exclusively under a desk surface.

While such apparatuses are useful, a number of improvements could be made. For example, since the demands of consumers cannot be predicted with complete accuracy, manufacturers of office equipment are forced to create two sets of products; one set that is used over a desk surface and one set that is used under the desk surface. It would be desirable to provide for an apparatus that allows a person to use it either over a desk surface or under a desk surface. This would not only provide the user with more choices for installation options and end uses, but it would also reduce the number of products that a manufacturer needs to produce and would reduce the number of products that a retailer needs to keep in stock.

In addition, it would be desirable to provide for an apparatus that can be easily adjustable to an optimal ergonomic position or configuration. Ergonomics relates to a discipline of dealing with the interaction between a worker and the worker's work environment. An ergonomic hazard is a workplace condition that places a worker at an increased risk of developing a musculoskeletal injury or which would otherwise increase the likelihood of other work performance problems. For example, one ergonomic hazard is an improperly positioned computer keyboard. It is well known that an improperly positioned keyboard and continuous typing using the improperly positioned keyboard may result in carpal tunnel syndrome.

To address the problem of ergonomic hazards, workplace tools such as chairs, trays, monitors, etc. are desirably positioned in an ergonomically optimized manner. Many large corporations hire ergonomic specialists to help workers adjust their work tools to optimal ergonomic positions to minimize injury and maximize comfort.

While ergonomic specialists are effective, many average consumers cannot afford to hire ergonomic specialists. Moreover, even if they could afford ergonomic specialists, ergonomic specialists are not always readily available. Even if they are available, the process of adjusting each and every workplace tool for a worker is a time consuming process even for an ergonomic specialist. Also, even if an ergonomic specialist is used, workplace tools can be moved over time due to cleaning personnel, etc. After the tools have been moved, a user will have a difficult time re-adjusting those workplace tools to their optimal ergonomic positions.

While many commercially available products are characterized as “ergonomic,” they are in fact often used improperly, because consumers do not have enough guidance on how to properly position or use them. For example, there are many commercially available “ergonomic” keyboard holders. However, the keyboard holder manufacturers do not tell the consumers how their keyboard holders should be adjusted so that they are positioned in the most ergonomically effective manner. Consumers often think that think that their chairs are being used in the most ergonomically effective way. However, they may not be used in the most ergonomically effective way. Consumers are thus left to guess as to how to position their “ergonomic” workplace tools.

Embodiments of the invention address these and other problems.

### SUMMARY OF THE INVENTION

Embodiments of the invention are directed to apparatus, systems, and methods.

One embodiment of the invention is directed to an apparatus for use over and under a desk surface, the apparatus comprising: a platform configured to support a monitor when the apparatus is over the desk surface; at least one support coupled to the platform for supporting the platform when the apparatus is over the desk surface; and at least one attachment mechanism for coupling the platform under the desk surface.

Another embodiment of the invention is directed to a method comprising: obtaining an apparatus including a platform and at least one support for use over or under a desk surface; attaching the apparatus under the desk surface; and placing the apparatus over the desk surface.

Yet other embodiments of the invention are directed to systems using the apparatus.

These and other embodiments of the invention are described in detail below.

### BRIEF DESCRIPTION OF THE DRAWINGS

FIG. 1 shows a perspective view of an apparatus according to an embodiment of the invention.

FIG. 2 shows a perspective view of the apparatus in FIG. 1. FIG. 2 shows the position of a first platform being reversed so that the apparatus can be used under a desk surface.

FIG. 3 shows an apparatus according to an embodiment of the invention when it is used under a desk.

FIGS. 4(a) and 4(b) show perspective assembled and exploded views of a leg in the apparatus in when the apparatus is in an under the desk position.

FIGS. 4(c) and 4(d) show perspective assembled and exploded views of a leg in the apparatus when the apparatus is an over the desk position.

FIG. 5 shows another apparatus according to an embodiment of the invention.

FIG. 6(a) shows a front view of an apparatus over a desk surface.

FIG. 6(b) shows a front cross-sectional view of the apparatus in FIG. 6(a).

FIGS. 7(a)-7(b) respectively show a person opening a box with the apparatus and the person measuring his hand against a reference guide.

FIGS. 7(c)-1 and 7(c)-2 show a person installing and using the apparatus over a desk surface.

FIGS. 7(d)-1 and 7(d)-2 show a person installing and using the apparatus under a desk surface.

FIG. 8 shows a reference guide according to an embodiment of the invention.

### DETAILED DESCRIPTION

One embodiment of the invention is directed to an apparatus for use over and under a desk surface. The apparatus includes a platform configured to support a monitor when the apparatus is over the desk surface. The apparatus includes at least one support coupled to the platform for supporting the platform when the apparatus is over the desk surface. In some embodiments, the at least one support may include four legs that are coupled to the platform. The at least one support may be adjustable so that the apparatus can be adjusted to its optimum ergonomic position or configuration. There may also be at least one attachment mechanism for coupling the first platform under the desk surface.

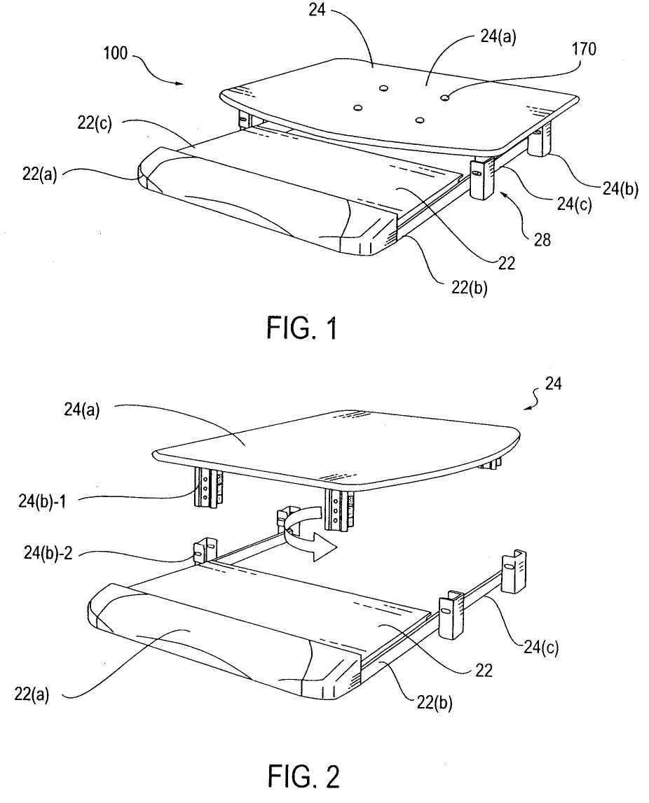

FIG. 1 shows an apparatus 100 according to an embodiment of the invention. The apparatus 100 is shown as it would be used over a desk surface. The apparatus 100 includes a platform 24 including an upper surface 24(a). A computer monitor (not shown) would rest on the platform 24. Holes 170 may be present in the platform 24 so that the apparatus 100 can be attached under a desk surface.

The platform 24 is supported by a plurality of adjustable supports 24(b). In this example, the adjustable supports 24(b) are in the form of four adjustable legs. There is one leg at each corner region of the platform 24. A window 28 in the adjustable support 24(b) shows a code corresponding to the apparatus' current ergonomic configuration or setting. A rail 24(c) is coupled to each side pair of adjustable supports 24(b).

As will be described in detail below, each adjustable support 24(b) can be adjusted so that it is either longer or shorter. Each adjustable support 24(b) may also have an adjustment guide coupled to it so that a user has an adjustment guide for adjusting the apparatus 100 to its optimal ergonomic position or configuration. As will be explained in detail below, the adjustment guide can have color codes. The color codes link body dimension measurements to an ergonomic setting in the adjustable apparatus.

A keyboard holder 22 is under the platform 24. The keyboard holder 22 includes a second platform 22(c) that supports a keyboard (not shown) and includes side rail structures 22(b) that are coupled to the rails 24(c) that are connected to the adjustable supports 24(b). The keyboard holder 22 may thus slide forward and backward using the mating rail pairs 22(b), 24(c).

A padded wrist-rest 22(a) is at a front portion of the keyboard holder 22. The padded wrist-rest 22(a) may be an adjustable wrist rest. Adjustable wrist rests are described in the U.S. Provisional Patent Applications described above, and are also described in U.S. patent application Ser. No. ______, entitled “Apparatus For Determining An Optimal Ergonomic Setup”, which is being filed on the same day as the present application (Attorney Docket No. 14572P-072320US).

FIG. 2 shows how the apparatus 100 can be converted so that it can be used under a desk surface. As shown, each adjustable support 24(b) includes a first support portion 24(b)-1 and a second support portion 24(b)-2. The first support portions 24(b)-1 are attached to the platform 24 and interface with the second support portions 24(b)-2, which are attached to the rails 24(c) and the keyboard holder 22.

To use the apparatus 100 as an “under the desk apparatus”, a first structure including the first support portions 24(b)-1 and the platform 24 can be separated from a second structure including the rails 24(c) and the second support portions 24(b)-2. The first structure is then turned 180 degrees so that the first support portions 24(b)-1 and the second support portions 24(b)-2 can again be engaged with each other. This is done so that the appropriate adjustment guide is presented to the user.

As will be explained in further detail below, the first support portions 24(b)-1 may have an adjustment guide including a number of different colors, where each color designates a different ergonomic position. Each second support portion 24(b)-2 may include a window that shows one color in the adjustment guide corresponding to the first support portions 24(b)-1 when the adjustable support 24(b) is at a selected height.

Since the apparatus 100 is adapted to be used under a desk surface or over a desk surface, the first support portions 24(b)-1 may include two adjustment guides. A first adjustment guide can be used when the apparatus 100 is used over a desk and a second adjustment guide can be used when the apparatus 100 is used under the desk surface. Two different adjustment guides are used, since the apparatus 100 can be used in two different positions for two different purposes.

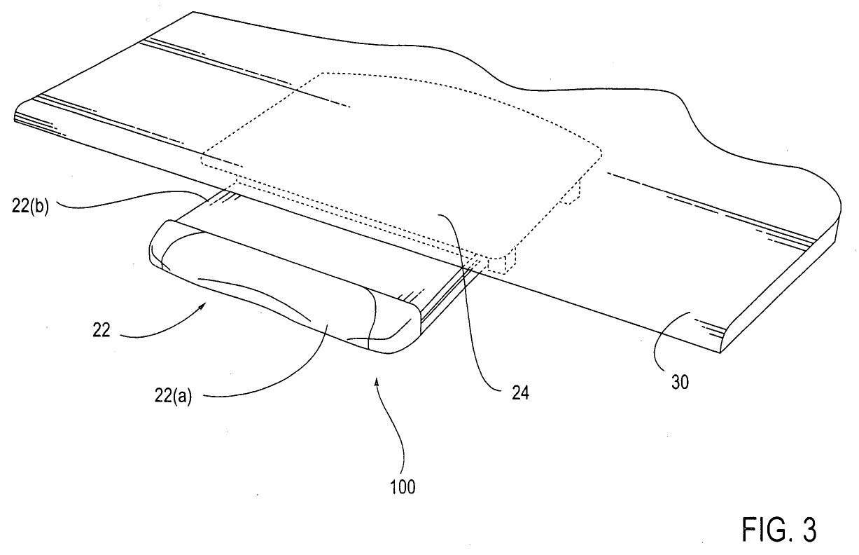

FIG. 3 shows the apparatus 100 when it is used under a desk surface 30. As shown, the platform 24 may be attached to the underside of the desk surface 30, and the keyboard holder 22 may slide forward or backward using the previously described rails. The apparatus 100 may also include a mouse support (not shown) which is connected to a keyboard holder 22 via an attachment element (not shown). Cable management areas in the form of notches or apertures may also be present in the apparatus.

Any suitable attachment mechanism (not shown) may be used to couple the platform 24 to the underside of the desk surface 30. One exemplary attachment mechanism comprises providing the platform 24 with holes. Screws, bolts, or the like may then be used to secure the platform 24 to the desk surface 30 using the holes. In another example, one or more brackets can be installed on the underside of the desk surface 30. The one or more brackets may receive the platform 24 so that the apparatus 100 is secured to the underside of the desk surface 30.

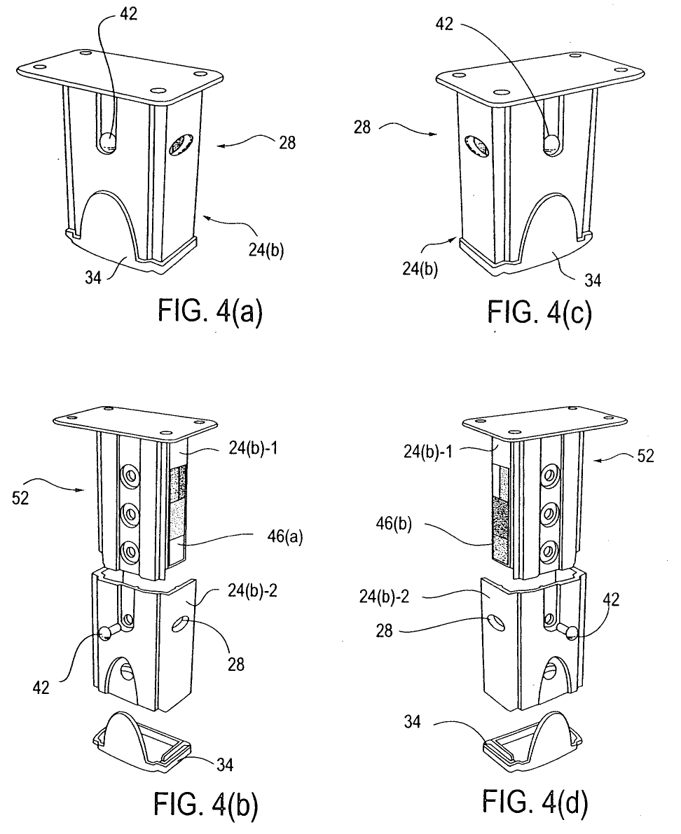

FIGS. 4(a)-4(b) shows a support 24(b) configured for the apparatus when the apparatus is over a desk surface. FIG. 4(a) shows an assembled view of the support 24(b), while FIG. 4(b) shows an exploded view of the support 24(b). As shown in FIG. 4(a), a window 28 is in a molded housing. The window 28 exposes a color in a first color-coded adjustment guide 46(a) in the housing. The color exposed through the window 28 corresponds to a color code associated with the user's particular ergonomic setup. A rubber foot 34 is also shown in FIG. 4(b).

In FIG. 4(b), the first support portion 24(b)-1 has a plurality of holes 52 arranged in a vertical line. The first support portion 24(b)-1 is inserted within a molded housing of the second support portion 24(b)-2. A pin structure 42 can be inserted into a side of the molding housing of the second support portion 24(b)-2 and into the appropriate aperture 52 of the second support portion 24(b)-2. The pin structure 42 maintains a particular spatial relationship between the first support portion 24(b)-1 and the second support portion 24(b)-2. The first color-coded adjustment guide 46(a) is on a first side of the first support portion 24(b)-2. The colored regions in the first color-coded adjustment guide 46(a) correspond to the positions of the apertures 52 in the first support portion 24(b)-1, and a selected colored region will show through the window 28 in the second support portion 24(b)-1 and will face the user.

FIGS. 4(c) and 4(d) show the support 24(b) configured for use when the apparatus is used over a desk surface. FIG. 4(c) shows an assembled view of the support 24(b), while FIG. 4(d) shows an exploded view of the support 24(b). A second color coded adjustment guide 46(b) is on the first support portion 24(b)-1 and on the side opposite to the first color coded adjustment guide 46(a) shown in FIG. 4(b). Another pin 42 may be inserted through the second support portion 24(b)-2 and into one of the apertures 52 in the first support portion 24(b)-1. The pin 42 maintains a predetermined spatial relationship between the first support portion 24(b)-1 and the second support portion 24(b)-2. When the apparatus is under the desk surface, the selected color in the second color-coded adjustment guide 46(b) faces the user.

As shown by FIGS. 4(a)-4(d), the apparatuses according to embodiments of the invention can include two or more adjustment guides for two or more different uses for the apparatus and/or two or more different positions for the apparatus. For example, the colored regions in the first color-coded adjustment guide 46(a) can correspond to appropriate monitor heights when the apparatus would be used over a desk surface. The colored regions in the second color coded adjustment guide 46(b) would be spaced so that they relate to appropriate keyboard depths when the apparatus is used under the desk surface. In this example, one color-coded adjustment guide is suitable for positioning a keyboard, while the other color-coded adjustment guide is suitable for positioning a monitor. The apparatus would be used in two different positions when it is used for these purposes.

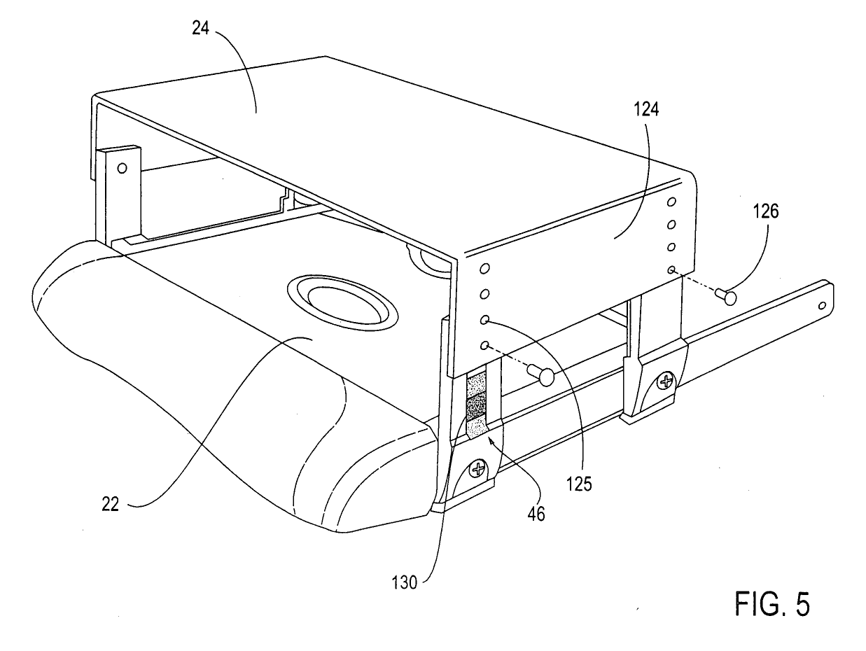

FIG. 5 shows another apparatus according to an embodiment of the invention. In this embodiment, the platform 24 has two supporting legs 124 with holes 125. A keyboard holder 22 is under the platform 24 and has a number of support portions 46 that extend upward from the keyboard holder 22. Pins 126 are inserted in the holes 125 and engage holes (not shown) in the support portions 46 to maintain a selected spatial relationship between the support portions 46 and the legs 124. As shown, there is a color coded adjustment guide 130 on the support portions 46. The platform 24 may be at the correct ergonomic position if the lower edge of the support legs 124 cover the appropriate color in the adjustment guide.

Unlike the embodiments shown in FIGS. 1-2, the embodiment in FIG. 5 has two long legs 124, rather than four smaller adjustment supports. In addition, color codes in the adjustment guide 130 do not show through a window in the embodiment in FIG. 5.

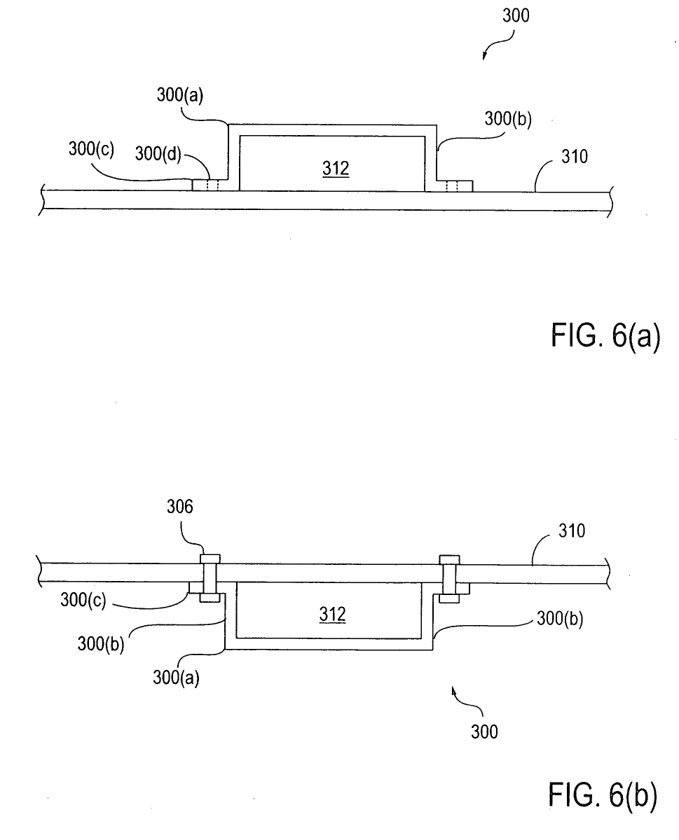

FIG. 6(a) shows another apparatus 300 according to another embodiment of the invention, as it would be used over a desk surface 310. The apparatus 300 in this embodiment does not have a sliding keyboard drawer, but is in the form of a monolithic body made of molded plastic or some other suitable material. The apparatus 300 has a platform 300(a) and side supports 300(b). Flanges 300(c) may be coupled to the supports 300(b) to provide additional stability and also a means for attaching the apparatus 300 to the desk surface 310 if desired. The apparatus 300 defines a space 312. A keyboard (not shown) or other items may be stored in the space 312. A monitor (not shown) may be present on the platform 300(a).

FIG. 6(b) shows the apparatus 300 in FIG. 6(a) as it would be used under the desk surface 310. As shown, coupling elements 306 (e.g. bolts, screws, etc.) may couple the flanges 300(c) to the underside of the desk surface 310. Holes may be provided in the desk surface 310 for this purpose. A keyboard (not shown) may be present in the space 312 and may rest on the side of the platform 300(a) closest to the desk surface 310.

This embodiment differs from the previously described embodiments, in that it is constructed as a single body. It also shows that embodiments of the invention may or may not have an ergonomic adjustment mechanism.

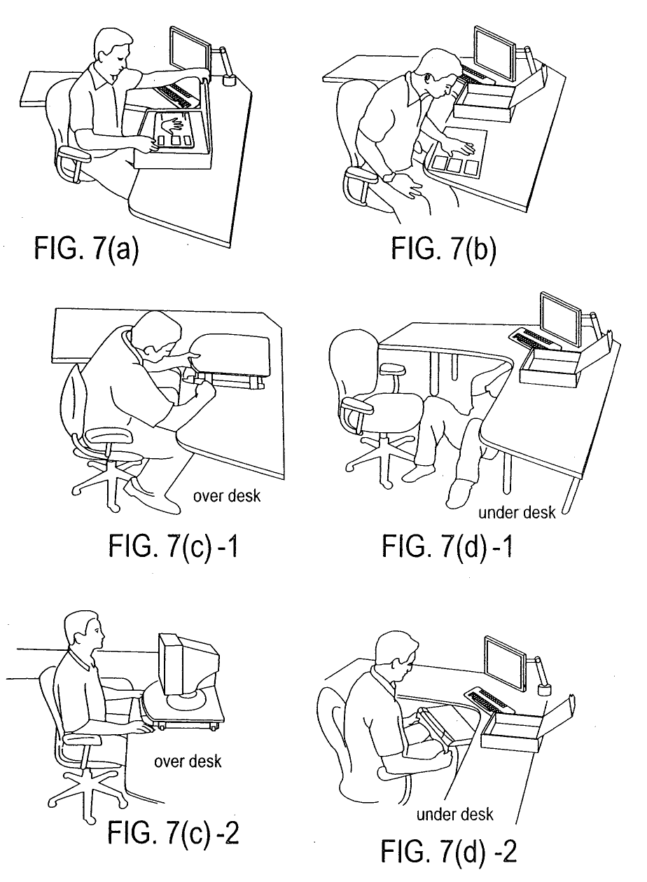

FIGS. 7(a)-7(d) show steps in a method according to an embodiment of the invention. In FIG. 7(a), a user opens a box and is presented with a reference guide and a quick installation guide. Details regarding an exemplary reference guide are below. In FIG. 7(b), the user measures his hand against the reference guide and can compare it to handprints in a plurality of differently sized handprints in the reference guide. Once a handprint has been selected, a corresponding color may also be selected.

FIGS. 7(c)-1 and 7(c)-2 show additional steps performed by a user when installing the apparatus over a desk surface. In FIG. 7(c)-1, the user installs the apparatus over a desk surface, and adjusts the adjustable supports to a selected color code so that the apparatus is ergonomically configured. In FIG. 7(c)-2, the user verifies the position of the apparatus using a validation element. The validation element may simply be a piece of cardboard or other spacer that allows a person to determine and verify the spacing between the top of the desk surface and the bottom of the platform in the apparatus.

FIGS. 7(d)-1 and 7(d)-2 show additional steps performed by a user when installing the apparatus under a desk surface. In FIG. 7(d)-1, the user installs the apparatus under the desk surface, and adjusts the adjustable supports to a selected color code so that the apparatus is ergonomically configured. In FIG. 7(d)-2, the user then uses a validation element to validate the position of the apparatus when it is attached under the desk surface. The validation element may simply be a piece of cardboard or other spacer that allows a person to determine and verify the spacing between the person's legs and the underside of the keyboard holder in the apparatus.

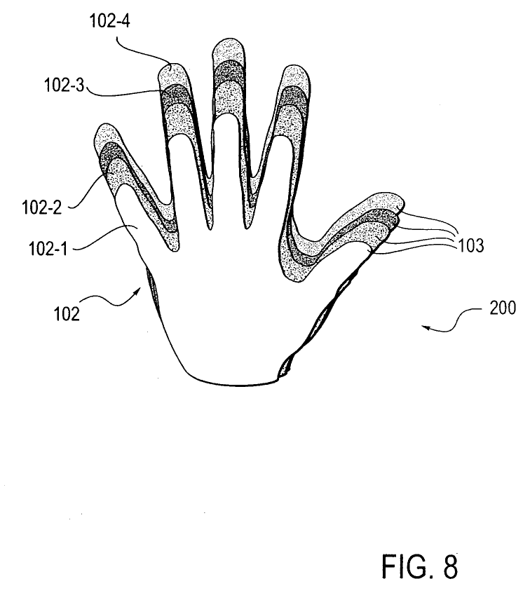

FIG. 8 shows a reference guide 200 comprising plurality of handprints 102 that may be used to determine a code in a plurality of color codes. As shown, various handprints 102 are labeled as handprints 102-1, 102-2, 102-3, 102-4. Although four handprints are shown, it will be understood that any number of handprints 102 may be provided.

Each handprint 102-1, 102-2, 102-3, 102-4 is associated with a different code in a coding scheme and has a size that is different than the other handprints. The outline 103 forming each handprint 102-1, 102-2, 102-3, 102-4 may form a measuring element. The handprints 102-1, 102-2, 102-3, 102-4 are associated with different colors. For example, handprints 102-1, 102-2, 102-3, 102-4 may be associated with or are colored green, blue, red, and yellow, respectively. More or less colors and measuring elements may be used in embodiments of the invention.

Each handprint 102 may also correspond to a certain percentage of males or females and may be sized to capture a range of hand sizes. For instance, green handprint 102-1 may have a height suitable for capturing users with hand sizes between about 6.18 inches and 7.39 inches. This may capture the 5th percentile of the females and the 25th percentile of males. Blue handprint 102-2 may have a height suitable for capturing users with hand heights between about 6.76 inches and 7.64 inches. This may capture the 25th percentile of the females and the 50th percentile of males. Red handprint 102-3 may have a height suitable for capturing users with hand heights between about 7.01 inches and 7.91 inches. This may capture the 50th percentile of the females and the 75th percentile of males. Yellow handprint 102-4 may have a height suitable for capturing users with hand heights between about 7.28 inches and 8.35 inches. This may capture the 75th percentile of the females and the 95th percentile of males. Although a single reference guide may be used for both males and females in this embodiment, in other embodiments, two or more reference guides may be used (e.g., one for males and one for females).

As noted above, for most individuals, the size of a user's hand approximates other dimensions of the user's body. For example, a user's hand size may be used to approximate the user's height, arm length, leg length, etc. The use of a user's hand as an ergonomic measuring tool is particularly preferable because a user can simply place his or her hand on the diagram shown in FIG. 8 and can determine his or her code. This allows products, when sold, to include diagrams like the one shown in FIG. 8 and a person can easily determine the code that provides that person with the optimal ergonomic adjustment.

Referring to FIG. 8, in order to determine a code, a user can place his hand on the handprints 102 shown in FIG. 8. The user then determines which handprint 102 most closely fits the user's hand. As shown, handprints 102 are of different sizes. The user may choose a certain handprint 102 if his/her hand substantially fits within one of the handprints.

Once an applicable handprint 102 is determined, the color associated with the handprint 102 is identified by the user. This color is a code in a coding scheme that may be used to adjust the apparatus as described above.

Other measurement systems may be used to determine a code in a coding scheme. For example, the length of a user's arm from the tip of the middle finger to the elbow may be used to determine the code. Also, the length of a user's leg from the floor to the knee may be used. In these examples, different ranges of measurements may correspond to different codes in a coding scheme. The interrelationship between body part lengths for a majority of individuals was previously determined by the U.S. Army (Natick 1989) in past studies.

The codes in the reference guide and the adjustment guide(s) in the apparatus are linked and are based on a number of assumptions. When the apparatus is used over a desk, it is assumed that the user's desk is about 28.5 inches tall, and measurements are based on an average of 17 inches from the base to the top of the monitor screen. It is also assumed that the user's eyes are parallel with the top of the screen, and the user's chair is at a proper height. When the apparatus is used under the desk, it is assumed that the desk is about 28.5 inches tall, and that the user's wrists and elbows are at the same height. It is also assumed that the user's chair is at the proper height, and that there is ergonomic benefit when the user's elbow is at the same height as the keyboard.

It is also noted that the apparatus can be separated into two products in some embodiments: the monitor stand (over desk) and a keyboard drawer (under desk) as one overall solution.

Embodiments of the invention have a number of advantages. As is apparent from the description above, embodiments of the invention can be used over or under a desk surface and may be used as an under the desk keyboard support or as an over the desk monitor stand. One product can be produced for two different uses. In addition, embodiments of the invention are easily adjustable to optimal ergonomic positions. Ergonomic specialists are not needed to optimize ergonomic adjustments in embodiments of the invention.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, one or more features of one or more embodiments of the invention may be combined with one or more features of other embodiments of the invention without departing from the scope of the invention.

A recitation of “a”, “an” or “the” is intended to mean “one or more” unless specifically indicated to the contrary. For example, “an adjustment guide” means that one or more adjustment guides may be present.

All patents, patent applications, publications, and descriptions mentioned above are herein incorporated by reference in their entirety for all purposes. None is admitted to be prior art.

1. An apparatus for use over and under a desk surface, the apparatus comprising:
a platform configured to support a monitor when the apparatus is over the desk surface;
at least one support coupled to the platform for supporting the platform when the apparatus is over the desk surface; and
at least one attachment mechanism for coupling the platform under the desk surface.

2. The apparatus of claim 1 wherein the platform is a first platform, and wherein the apparatus comprises a second platform, wherein the first platform is over the second platform when the apparatus is used over the desk surface and is used under the desk surface.

3. The apparatus of claim 1 wherein the platform is a first platform, and wherein the apparatus comprises a second platform and rails coupled to the at least one support, wherein the first platform is over the second platform when the apparatus is used over the desk surface and is used under the desk surface and wherein the second platform is adapted to move forward or backward using the rails.

4. The apparatus of claim 1 wherein the at least one support includes four legs.

5. The apparatus of claim 1 further comprising an adjustment guide for ergonomically adjusting the at least one support so that the apparatus is in an ergonomically optimized configuration.

6. The apparatus of claim 1 further comprising an adjustment guide for ergonomically adjusting the at least one support so that the apparatus is in an ergonomically optimized configuration, wherein the adjustment guide comprises color codes.

7. The apparatus of claim 1 further comprising a second platform coupled to the at least one support, a first ergonomic adjustment guide on the at least one support for adjusting the height of the at least one support when the apparatus is over the desk surface, and a second ergonomic adjustment guide on the at least one support for adjusting a depth of a second platform when the apparatus is under the desk surface.

8. The apparatus of claim 1 wherein the at least one support includes at least one adjustable support.

9. The apparatus of claim 1 wherein the platform is a first platform and wherein the apparatus further comprises a second platform under the first platform, wherein the first platform is adapted to support a keyboard when the apparatus is over the desk surface and under the desk surface, and wherein the first platform is adapted to support a monitor when the apparatus is over the desk surface, but not under the desk surface.

10. The apparatus of claim 1 wherein the platform is a first platform, and wherein the attachment mechanism comprises bolts or screws that are adapted to pass through holes in the first platform.

11. A system comprising:
the apparatus of claim 1; and
a reference guide for ergonomically adjusting the apparatus of claim 1 to an optimal ergonomic configuration.

12. The system of claim 11 wherein the reference guide comprises a plurality of color codes.

13. A method comprising:
obtaining an apparatus including a platform and at least one support for use over or under a desk surface;
attaching the apparatus under the desk surface; and
placing the apparatus over the desk surface.

14. The method of claim 13 wherein the apparatus includes a second platform for supporting a keyboard.

15. The method of claim 13 wherein the at least one support comprises four legs and wherein the apparatus includes rails coupled to pairs of legs.

16. The method of claim 13 further comprising placing a monitor on the platform when the apparatus is over the desk surface.

17. The method of claim 13 further comprising, ergonomically adjusting when the apparatus when the apparatus is over the desk surface.

18. The method of claim 13 further comprising, ergonomically adjusting when the apparatus when the apparatus is under the desk surface.

19. The method of claim 13 further comprising separating the platform from the at least one support, and reversing the orientation of the platform with respect to the at least one support depending on whether the apparatus is over the desk surface or under the desk surface.

20. The method of claim 13 wherein the platform is a first platform and the apparatus further comprises a second platform under the first platform and wherein the method further comprises placing a keyboard on the first platform when the first platform is under the desk surface and placing a monitor on the first platform when the apparatus is over the desk surface.
